(19) United States
(12) Patent Application Publication
(10) Pub. No.: US 2024/0277181 A1
(43) Pub. Date: Aug. 22, 2024

(54) MILK WARMER

(71) Applicant: SMILY MIA, LLC, Kodiak, AK (US)

(72) Inventor: Yelong Huang, Kodiak, AK (US)

(21) Appl. No.: 18/650,405

(22) Filed: Apr. 30, 2024

(51) Int. Cl. A47J 36/24

(52) U.S. Cl. CPC A47J 36/2433

(57) ABSTRACT

The utility model relates to the technical field of maternal and infant supplies, and discloses a milk warmer. The milk warmer includes: a base; a control panel, where the control panel is disposed on the base, and the control panel is configured to receive a signal and output the signal; a heating assembly, where the heating assembly is disposed on the base, the heating assembly is driven by the control panel, and a clamping slot is provided on an outer periphery of the heating assembly; a heating connector, where the heating connector is connected to an external nursing bottle, and the heating connector is fastened to the clamping slot; and a pressing switch, where the pressing switch is disposed on a side of the clamping slot, at least one part of the pressing switch extends to the clamping slot, and the pressing switch unlocks the heating connector by driving with an external force. The utility model has advantages of simple use, available for a user to fetch, and suitable for actual use.

### TECHNICAL FIELD

The utility model relates to the technical field of maternal and infant supplies, and in particular to a milk warmer.

### BACKGROUND

Baby's constitution is weak, and requirements for a temperature of drinking milk are high. Therefore, a milk warmer is emerged for heating milk and juice and keeping them warm. This enables temperatures of the milk and juice to be suitable for drinking by babies. Because the functions of heat preservation and heating of the milk warmer, the milk warmer is also suitable for the elderly.

At present, a structure of a milk warmer on the market is as follows: An adapter is disposed between the milk warmer and a nursing bottle, one end of the adapter has an external thread that is connected to the milk warmer in a threaded manner, and the other end of the adapter has an internal thread that is connected to the nursing bottle in a threaded manner.

Due to the structure of the milk warmer, users does not conveniently fetch the nursing bottle. For example, when the users remove the milk warmer, the milk warmer can be removed by screwing the thread.

Therefore, it is necessary to improve this structure.

### SUMMARY

The objective of the utility model is to overcome the shortcomings of the prior art. A milk warmer is provided. An objective of the utility model is to design a milk warmer with a novel structure. A nursing bottle is unlocked by using a pressing switch, to conveniently fetch the nursing bottle, and resolve the technical problems in the background.

To resolve the foregoing technical problem, embodiments of the utility model provide the following technical solutions. A milk warmer includes: a base; a control panel, where the control panel is disposed on the base, and the control panel is configured to receive a signal and output the signal; a heating assembly, where the heating assembly is disposed on the base, the heating assembly is driven by the control panel, and a clamping slot is provided on an outer periphery of the heating assembly; a heating connector, where the heating connector is connected to an external nursing bottle, and the heating connector is fastened to the clamping slot; and a pressing switch, where the pressing switch is disposed on a side of the clamping slot, at least one part of the pressing switch extends to the clamping slot, and the pressing switch unlocks the heating connector by driving with an external force.

Further, the pressing switch includes a pressing portion and an engaging portion that is connected to the pressing portion, the engaging portion extends to the clamping slot, the pressing portion is hinged to the base, and the pressing portion is rotated and opened by pressing the engaging portion with an external force.

Further, a mounting port that is configured to mount the pressing switch is disposed on the base, convex columns that are disposed opposite to each other are disposed at the mounting port, and an elastic member is disposed between the pressing portion and the mounting port; and the pressing portion is movably connected to the convex columns through a rotating shaft, and the pressing portion is pressed with an external force, to drive the engaging portion to be rotated and opened.

Further, the mounting port includes more than one guide port, the pressing portion has a guide bar that is fitted with the guide port, and the guide bar has a hook portion that is fitted with the guide port.

Further, a limiting portion that fastens the heating connector is disposed on the clamping slot, the limiting portion extends horizontally, and the limiting portion and the engaging portion fasten the heating connector.

Further, the milk warmer includes a Hall switch, where the Hall switch is disposed at a position of the clamping slot, and the Hall switch is connected to a circuit under pressing of the heating connector.

Further, the control panel includes a touch switch, and the touch switch is configured to control an operating state or an operating parameter of the milk warmer.

Further, the milk warmer includes a protective sleeve, where the protective sleeve is embedded at a position of the clamping slot, and the protective sleeve is configured to protect the heating assembly.

Further, the control panel includes a detection module, and the detection module is configured to detect an upright state of the milk warmer and feed back a detection signal to the control panel.

Further, the heating assembly includes a silicone base, a membrane body disposed on the silicone base, a heating wire disposed in the membrane body, a thermistor disposed in the membrane body, and a rubber member disposed on the silicone base, the heating wire extends outside the silicone base by using a wire, and the rubber member is configured to seal a wire port formed between the wire and the silicone base.

Compared with the prior art, the utility model has the following beneficial effects:
1. It is convenient to fetch. The clamping slot is disposed on the base and fitted with the pressing switch, to connect the nursing bottle to the heating connector. The heating connector can be clamped and fixed, by pressing the pressing switch, in the clamping slot for heating. The nursing bottle can be taken off by pressing the pressing switch. In comparison to a conventional threaded connection, fetching is simpler.
2. The pressing switch can be pressed based on a lever principle, to enable pressing to be in accord with an inertia operation of a user, so that effort is saved.
3. Due to the Hall switch, the milk warmer does not work when the user does not place the nursing bottle in place, so that use is more safe, and misoperations of the user are prevented.
4. Due to the silicone heating assembly, the milk warmer has advantages of cooling down quickly and raising a temperature quickly. The milk warmer is not directly in contact with milk or liquid in use, so that the milk warmer does not need to be cleaned.
5. The detection module is configured to detect a placement state of the milk warmer, and determine, based on the placement state of the milk warmer, whether to drive the milk warmer to work, so that use safety is ensured.

### BRIEF DESCRIPTION OF DRAWINGS

FIG. 1 is a schematic diagram of a structure of the utility model;

FIG. 2 is a schematic diagram of an exploded structure of the utility model;

FIG. 3 is a schematic diagram of a partial structure of the utility model;

FIG. 4 is a schematic diagram of a partial structure of the utility model;

FIG. 5 is a schematic diagram of an internal structure of a base;

FIG. 6 is a schematic diagram of an internal structure of a pressing switch;

FIG. 7 is a schematic diagram of an internal structure of a pressing switch; and

FIG. 8 is a schematic diagram of a structure of a base.

Reference numerals: 1: base; 2: control panel; 3: heating assembly; 4: clamping slot; 5: heating connector; 6: pressing switch; 7: pressing portion; 8: engaging portion; 9: mounting port; 10: convex column; 11: guide port; 12: guide bar; 13: hook portion; 14: limiting portion; 15: Hall switch; 16: touch switch; 17: protective sleeve.

### DESCRIPTION OF EMBODIMENTS

The utility model is further described below in detail with reference to the accompanying drawings.

The embodiments described below with reference to the accompanying drawings are exemplary, and are only used to explain the present disclosure but should not be construed as a limitation to the present disclosure. In the description of this application, it should be understood that the orientations or position relationships indicated by terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” and the like are orientations or position relationships shown based on the accompanying drawings, for ease of describing the utility model and simplifying the description only, rather than indicating or implying that the indicated device or element must have a particular orientation or be constructed and operated in a particular orientation. Therefore, these terms cannot be construed as a limitation to the utility model. In addition, the terms “first” and “second” mentioned below are merely intended for a purpose of description, and shall not be understood as an indication or implication of relative importance or implicit indication of the number of indicated technical features. Therefore, a feature limited by “first” or “second” may explicitly or implicitly include one or more features. In the description of this application, “a plurality of” and “multiple” means two or more, unless otherwise specifically defined. In this application, unless otherwise clearly specified and defined, meanings of terms “install”, “connect with”, “connect to” and “fixed to” should be understood in a broad sense. For example, the connection may be a fixed connection, a removable connection, or an integral connection; may be a mechanical connection or an electrical connection; may be a direct connection or an indirect connection via a medium; or may be intercommunication between two components. A person of ordinary skill in the art may understand specific meanings of the foregoing terms in this application according to specific cases. In this application, unless otherwise expressly specified and defined, that a first feature is “above” or “under” a second feature may include that the first feature is in direct contact with the second feature, or that the first feature and the second feature are not in direct contact with each other but are in contact by using another feature between them. In addition, that the first feature is “over”, “above”, and “on” the second feature includes that the first feature is directly above and diagonally above the second feature, or simply indicates that a horizontal height of the first feature is larger than that of the second feature. The case where the first feature is “beneath”, “below”, and “under” the second feature includes that the first feature is directly below and diagonally below the second feature, or simply indicates that the altitude of the first feature is lower than that of the second feature.

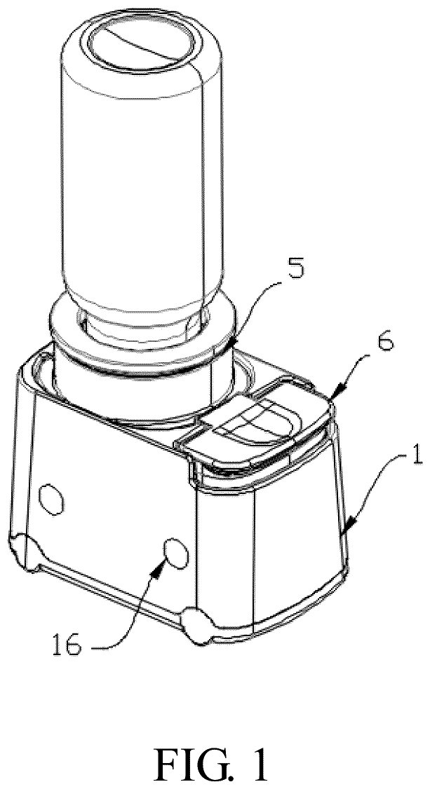

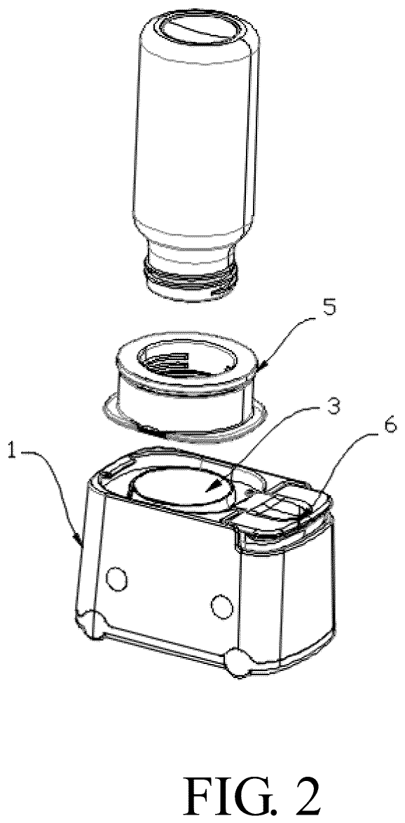

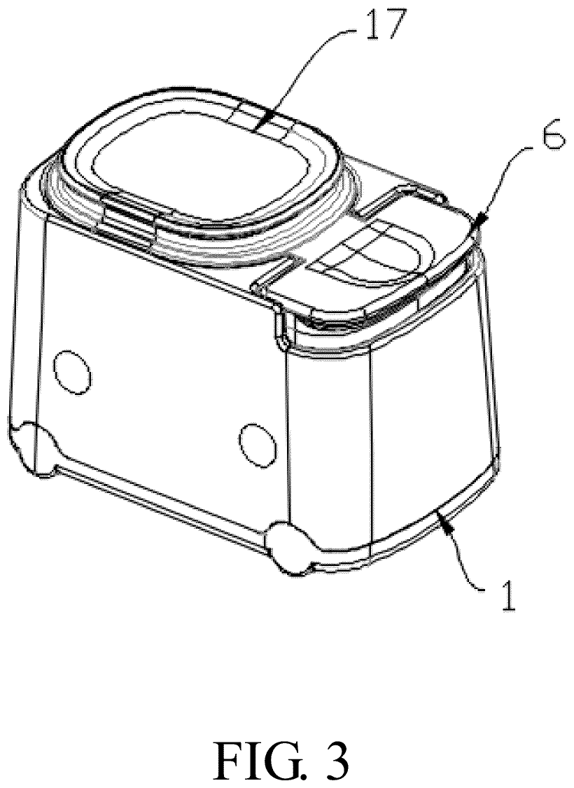

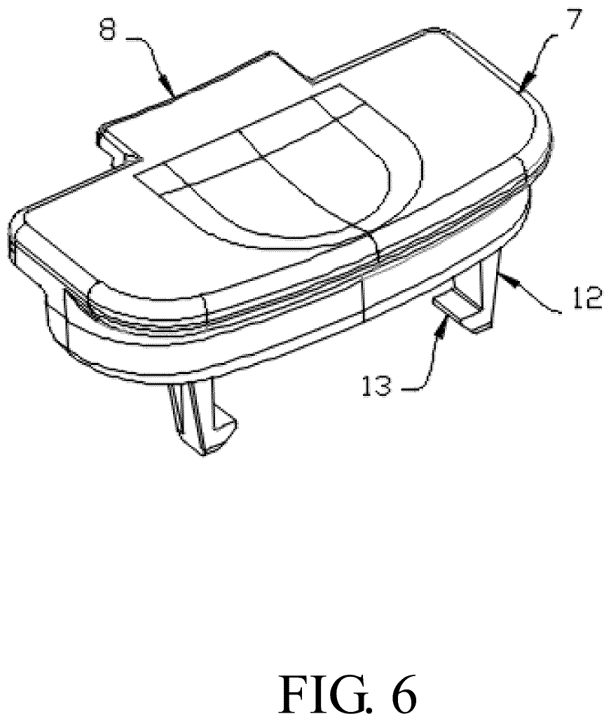

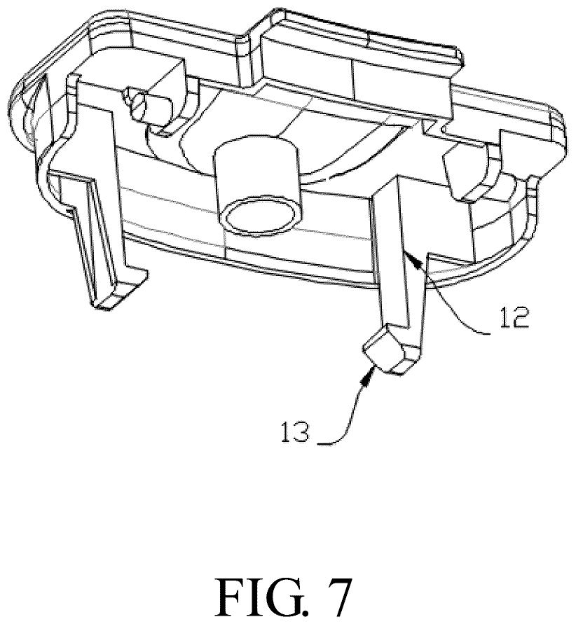

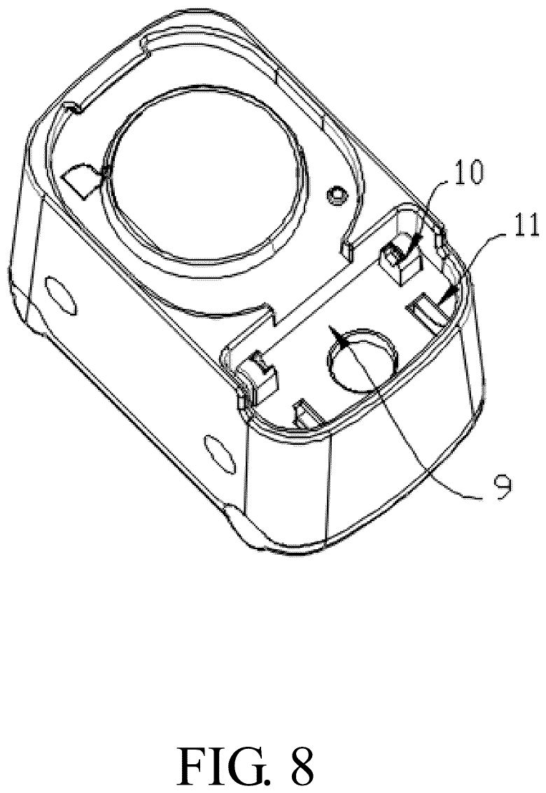

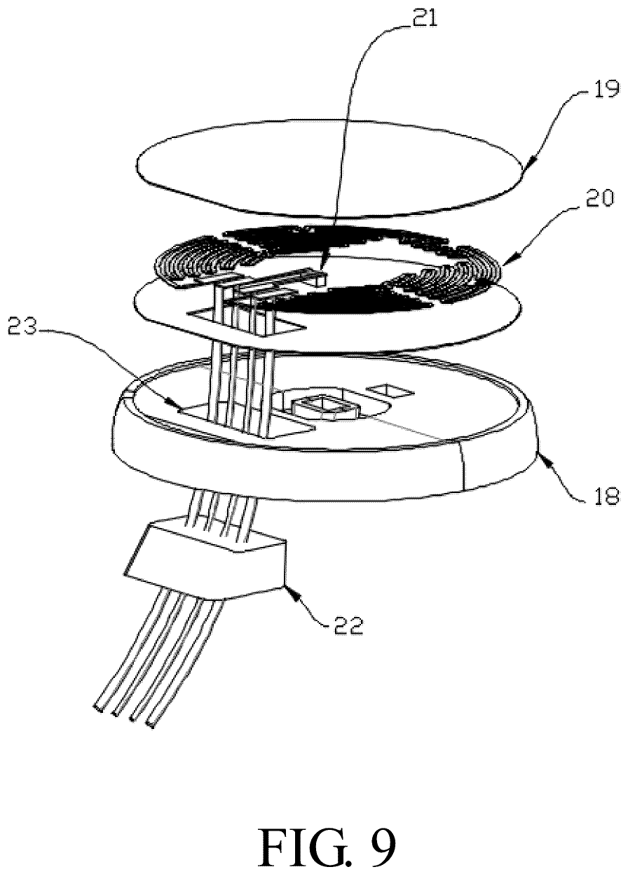

Refer to FIG. 1 to FIG. 8. A milk warmer is provided. The milk warmer includes: a base 1; a control panel 2, where the control panel 2 is disposed on the base 1, and the control panel 2 is configured to receive a signal and output the signal; a heating assembly 3, where the heating assembly 3 is disposed on the base 1, the heating assembly 3 is driven by the control panel 2, and a clamping slot 4 is provided on an outer periphery of the heating assembly 3; a heating connector 5, where the heating connector 5 is connected to an external nursing bottle, and the heating connector 5 is fastened to the clamping slot 4; and a pressing switch 6, where the pressing switch 6 is disposed on a side of the clamping slot 4, at least one part of the pressing switch 6 extends to the clamping slot 4, and the pressing switch 6 unlocks the heating connector 5 by driving with an external force.

In view of the technical problems in the background, a milk warmer is provided. The milk warmer may be used via a built-in battery disposed in the base 1 or in a manner of connecting the milk warmer to a socket through a wire. The heating assembly 3 is disposed at a position of an upper end surface of the base 1, and the clamping slot 4 is provided at the outer periphery of the heating assembly 3. During use, the user snap-fits the nursing bottle with the heating connector 5, and presses the pressing switch 6, to align the heating connector 5 to the position of the heating assembly 3, and clamp the heating connector 5 at a position of the clamping slot 4. When the user releases the pressing switch 6, the heating connector 5 is fixed by using the pressing switch 6. Under action of the heating assembly 3, liquid in the nursing bottle is heated. After the liquid is heated, the nursing bottle can be quickly removed from the position of the clamping slot 4 by pressing the pressing switch 6. Compared with a conventional threaded connection structure, in this structural design, the nursing bottle is more conveniently fetched, locked or unlocked by pressing the pressing switch 6, which is convenient for the user to use.

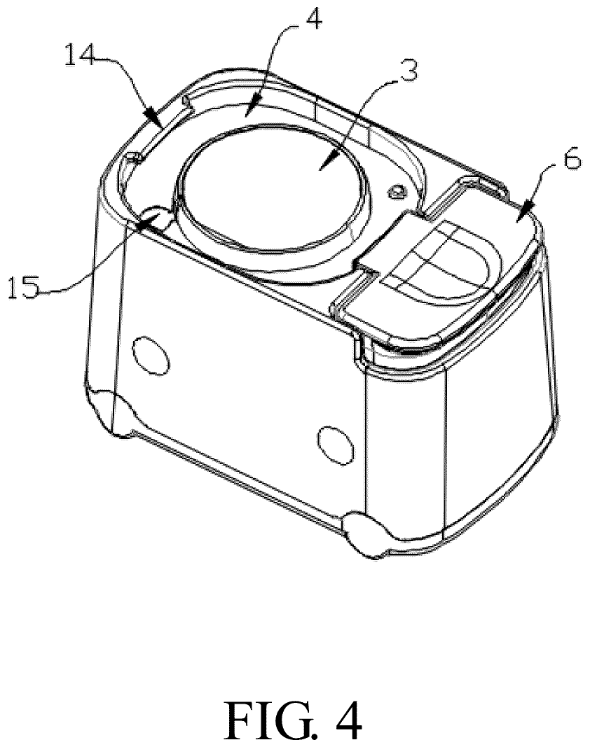

As shown in FIG. 4 to FIG. 8, the pressing switch 6 includes a pressing portion 7 and an engaging portion 8 that is connected to the pressing portion 7. The engaging portion 8 extends to the clamping slot 4, the pressing portion 7 is hinged to the base 1, and the pressing portion 7 is pressed with an external force, to drive the engaging portion 8 to be opened.

During use, the elastic member is disposed between the pressing portion 7 and the base 1. Because the pressing portion 7 is hinged to the base 1, when the user applies a force on the pressing portion 7, the pressing portion 7 rotates due to the lever principle, and the engaging portion 8 is removed from the position of the clamping slot 4, to facilitate taking out the nursing bottle. When the user withdraws the force, the pressing portion 7 is reset, to drive the engaging portion 8 to rotate to the clamping slot 4, and the engaging portion 8 is engaged to the heating connector 5 for fixing.

A mounting port 9 that is configured to mount the pressing switch 6 is disposed on the base 1, convex columns 10 that are disposed opposite to each other are disposed at the mounting port 9, and an elastic member is disposed between the pressing portion 7 and the mounting port 9. The pressing portion 7 is movably connected to the convex columns 10 through a rotating shaft, and the pressing portion 7 is pressed with an external force, to drive the engaging portion 8 to be rotated and opened.

To facilitate mounting of the pressing switch 6, the mounting port 9 is provided on the base 1. During use, the pressing portion 7 is fitted in a position of the mounting port 9, and rotates around the positions of the convex columns 10, and the engaging portion 8 rotates to perform locking or unlocking.

Specifically, the mounting port 9 includes more than one guide port 11. The pressing portion 7 has a guide bar 12 that is fitted with the guide port 11, and the guide bar 12 has a hook portion 13 that is fitted with the guide port 11.

During implementation, there are two guide ports 11, and there are correspondingly two guide bars 12. The hook portion 13 is disposed on the guide bar 12. When the user applies a force on the pressing portion 7, the guide bar 12 of the pressing portion 7 may move downward along the guide port 11, to take out the nursing bottle. When the user removes the force, the pressing portion 7 is reset under action of the elastic member. The hook portion 13 of the guide bar 12 abuts against the guide port 11 to complete resetting of the pressing portion 7.

As shown in FIG. 4, a limiting portion 14 that fastens the heating connector 5 is disposed on the clamping slot 4, the limiting portion 14 extends horizontally, and the limiting portion 14 and the engaging portion 8 fasten the heating connector 5.

During implementation, to facilitate fixing of the heating connector 5, the limiting portion 14 is disposed in the position of the clamping slot 4, and the limiting portion 14 is disposed opposite to the engaging portion 8. When the heating connector 5 is disposed in the clamping slot 4, the limiting portion 14 and the engaging portion 8 are clamped and fastened to the heating connector 5.

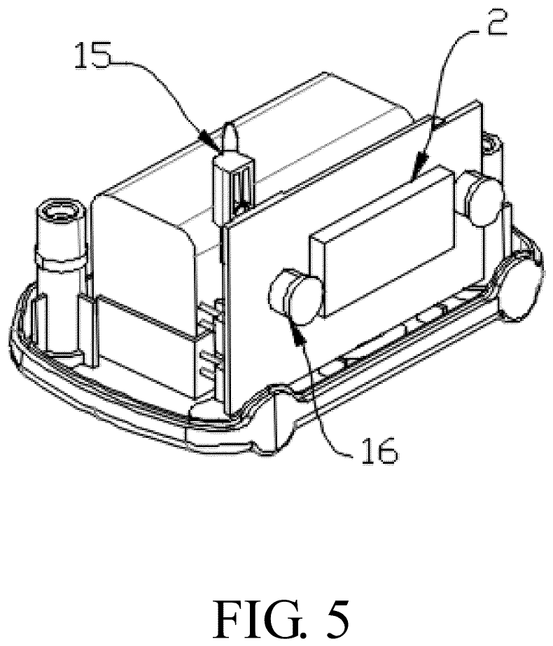

As shown in FIG. 4 and FIG. 5, the milk warmer further includes a Hall switch 15. The Hall switch 15 is disposed at a position of the clamping slot 4, and the Hall switch 15 is connected to a circuit under pressing of the heating connector 5.

A current milk warmer can be used in a case in which the nursing bottle is not mounted in place, resulting in a potential use safety problem. In view of this, the clamping slot 4 is configured to mount the heating connector 5, and the Hall switch 15 is disposed at the position of the clamping slot 4. During use, when the nursing bottle and the heating connector 5 are assembled in the clamping slot 4, the Hall switch 15 moves downward to be connected to the circuit, to determine whether the nursing bottle is placed in place, thereby improving use safety.

Specifically, the control panel 2 includes a touch switch 16. The touch switch 16 is configured to control an operating state or an operating parameter of the milk warmer. The touch switch 16 includes a warming temperature adjustment button and a confirmation button.

Further, the milk warmer further includes a protective sleeve 17. The protective sleeve 17 is embedded at the position of the clamping slot 4, and the protective sleeve 17 is configured to protect the heating assembly 3.

The protective sleeve 17 is matched with the clamping slot 4. When the milk warmer does not need to be used, the protective sleeve 17 is clamped in the clamping slot 4, to protect an internal component of the base 1, and prevent a foreign matter from entering the base 1.

Further, the control panel 2 includes a detection module, and the detection module is configured to detect an upright state of the milk warmer and feed back a detection signal to the control panel 2.

A color value detection module detects a status of the milk warmer. For example, when the milk warmer is in a non-upright state, and the detection module detects the signal and feeds back the signal to the control panel 2, the milk warmer cannot be driven. This improves use safety.

The heating assembly 3 includes a silicone base 18, a membrane body 19 disposed on the silicone base 18, a heating wire 20 disposed in the membrane body 19, a thermistor 21 disposed in the membrane body 19, and a rubber member 22 disposed on the silicone base 18. The heating wire 20 extends outside the silicone base 18 by using a wire, and the rubber member 22 is configured to seal a wire port 23 formed between the wire and the silicone base 18.

During implementation, the heating assembly 3 has advantages of cooling down quickly and raising a temperature quickly. The milk warmer is not directly in contact with milk or liquid, so that the milk warmer does not need to be cleaned. A technical solution used is that a food-grade silicone is used as a base, and a slot for mounting the thermistor 21 is disposed on an upper end surface of the silicone base 18. The heating wire 20 is compounded via two polyimide membranes to form the membrane body. The wire port 23 is provided on the silicone base 18, and the wire extends outside from the wire port. The rubber member 22 seals the wire port 23 via liquid drop glue.

The above described are not intended to limit the utility model in any form. Any minor changes, equivalent variations and modifications made to the above embodiments based on the technical essence of the utility model should fall within the scope defined by the technical solutions of the utility model.

1. A milk warmer, comprising:
a base;
a control panel, wherein the control panel is disposed on the base, and the control panel is configured to receive a signal and output the signal;
a heating assembly, wherein the heating assembly is disposed on the base, the heating assembly is driven by the control panel, and a clamping slot is provided on an outer periphery of the heating assembly;
a heating connector, wherein the heating connector is connected to an external nursing bottle, and the heating connector is fastened to the clamping slot; and
a pressing switch, wherein the pressing switch is disposed on a side of the clamping slot, at least one part of the pressing switch extends to the clamping slot, and the pressing switch unlocks the heating connector by driving with an external force.

2. The milk warmer according to claim 1, wherein the pressing switch comprises a pressing portion and an engaging portion that is connected to the pressing portion, the engaging portion extends to the clamping slot, the pressing portion is hinged to the base, and the pressing portion is rotated and opened by pressing the engaging portion with an external force.

3. The milk warmer according to claim 2, wherein a mounting port that is configured to mount the pressing switch is disposed on the base, convex columns that are disposed opposite to each other are disposed at the mounting port, and an elastic member is disposed between the pressing portion and the mounting port; and the pressing portion is movably connected to the convex columns through a rotating shaft, and the pressing portion is pressed with an external force, to drive the engaging portion to be rotated and opened.

4. The milk warmer according to claim 2, wherein the mounting port comprises more than one guide port, the pressing portion has a guide bar that is fitted with the guide port, and the guide bar has a hook portion that is fitted with the guide port.

5. The milk warmer according to claim 2, wherein a limiting portion that fastens the heating connector is disposed on the clamping slot, the limiting portion extends horizontally, and the limiting portion and the engaging portion fasten the heating connector.

6. The milk warmer according to claim 1, comprising a Hall switch, wherein the Hall switch is disposed at a position of the clamping slot, and the Hall switch is connected to a circuit under pressing of the heating connector.

7. The milk warmer according to claim 1, wherein the control panel comprises a touch switch, and the touch switch is configured to control an operating state or an operating parameter of the milk warmer.

8. The milk warmer according to claim 1, comprising a protective sleeve, wherein the protective sleeve is embedded at a position of the clamping slot, and the protective sleeve is configured to protect the heating assembly.

9. The milk warmer according to claim 1, wherein the control panel comprises a detection module, and the detection module is configured to detect an upright state of the milk warmer and feed back a detection signal to the control panel.

10. The milk warmer according to claim 1, wherein the heating assembly comprises a silicone base, a membrane body disposed on the silicone base, a heating wire disposed in the membrane body, a thermistor disposed in the membrane body, and a rubber member disposed on the silicone base, the heating wire extends outside the silicone base by using a wire, and the rubber member is configured to seal a wire port formed between the wire and the silicone base.
